(19) United States
(12) Patent Application Publication
(10) Pub. No.: US 2026/0264794 A1
(43) Pub. Date: Sep. 10, 2026

(54) PERSONAL MOBILITY VEHICLES

(71) Applicant: VERTISCOOT LIMITED, Paignton Devon (GB)

(72) Inventor: Ian GRAY, Paignton Devon (GB)

(21) Appl. No.: 19/166,315

(22) PCT Filed: Mar. 18, 2024
(86) PCT No.: PCT/GB2024/050728

§ 371 Date: Sep. 17, 2025

(30) Foreign Application Priority Data
Mar. 19, 2023 (GB) 2303980.3

(51) Int. Cl. B62K 5/007; B62J 1/18

(52) U.S. Cl. CPC B62K 5/007; B62J 1/18; B62K 2202/00

(57) ABSTRACT

A personal mobility vehicle comprising a chassis, including a platform upon which a user is supported by, or stands upon, whilst mounting, or operating the vehicle, ground-engaging wheels upon which the chassis is supported, and in which the vehicle comprises at least one body stabilising support.

### FIELD OF THE INVENTION

This invention relates to personal mobility vehicles.

Personal mobility vehicles include mobility scooters and electric wheelchairs, are well-known and used increasingly more by elderly and disabled people.

Mobility scooters typically comprise a chassis/frame supported by 3 or more wheels, an upright tiller with a handlebar at the front which rotates about a generally vertical axis for steering, power means, power control means and a seat for the user to sit on whilst operating the vehicle.

Electric wheelchairs typically comprise a chassis/frame supported by 2 or more wheels, possibly 2 or more castors, possibly 2 or more idler wheels, a joystick for steering and power control means, and a seat for the user to sit on whilst operating the vehicle.

There are examples of electric wheelchairs that have the ability to raise the seated user directly vertically to a certain extent, facilitated by one or more electric moto, whilst the user remains seated. But such vehicles have many disadvantages, limitations and are very expensive to purchase.

There are examples of electric wheelchairs that have the ability to raise a seated user to a more vertical position, facilitated by one or more electric motors, with straps to hold the user's body in position on the seat, whilst the user remains seated. But such vehicles also have many disadvantages, limitations and are very expensive to purchase.

There are also examples of scooters that allow the user to adopt a standing position whilst operating the vehicle but such vehicles also have many disadvantages, limitations and are very expensive to purchase.

Conventional personal mobility vehicles, such as those described above, provide a certain level of independence for the user but suffer from some or all of the following disadvantages and limitations:

Users of conventional personal mobility vehicles are unable to readily choose different body and postural positions such as standing, leaning, resting, perching, high-sitting, sitting, reclining; lying and all positions in between said positions, whilst operating the mobility vehicle, according to their preference, needs, environment, medical condition etc.

The mobility vehicle may not allow easy and safe access for the user to mount and dismount the vehicle and to allow the user to easily and readily choose their preferred body and postural position whist mounting or operating the vehicle.

The vast majority of conventional personal mobility vehicles only allow the user the choice of sitting, and remaining on the seat.

If the vehicle is a mobility scooter that allows the user to adopt a sitting position whilst operating the vehicle, the choice of body positioning is very restrictive and the user does not have the choice of changing their position or body posture to and from sitting; reclining; lying: high-sitting; perching; supported forward, rearward or sideward leaning or resting; standing, or any position in between said positions whilst operating the vehicle.

If the vehicle is a mobility scooter that allows the user to adopt a standing position whilst operating the vehicle, the choice of body positioning is very restrictive and the user does not have the choice of changing their position and body posture to and from standing; supported forward, rearward or sideward leaning or resting; perching; high-sitting; sitting; reclining; lying, or any position in between said positions whilst operating the vehicle.

Therefore, with any conventional mobility vehicle, there is a minimal choice of adopting different body positions and body postures whilst mounted upon, or operating, the vehicle.

Furthermore, with any conventional mobility vehicle, there is a minimal ability to safely change body positions and body postures whilst mounted upon, or operating, the vehicle.

This can lead to further disadvantages and physical and mental health problems such as:

Reduced activity; which can lead to an increased susceptibility to weight gain, obesity, osteoporosis, reduced muscular strength, diabetes, poor blood circulation, problems with digestion etc.

Other disadvantages that may be encountered by users of personal mobility vehicles include:

Inability for the vehicle to be easily folded or dismantled for transportation or in order to be stored.

Limited adjustability of the vehicle's component parts, in particular the front and rear columns, handlebars and seat.

The vehicle may have, or give a sense of, instability, particularly when the vehicle is turning and especially when the vehicle is being driven at full speed, leading to problems such as safety concerns.

The vehicle may have poor or limited manoeuvrability.

The vehicle may not be suitable for both indoor and outdoor terrain and environments.

The vehicle may not be able, or easily able, to be controlled by an attendant, carer or companion.

The vehicle may not be cost-effective with respect to production costs and/or be very expensive or unaffordable to purchase.

Given the above disadvantages and limitations of conventional and presently-available personal mobility vehicles such as mobility scooters and electric wheelchairs, there is a growing requirement for affordable, safe, stable, reliable, versatile and healthier personal mobility vehicles which, in particular, provide a maximal choice of body and postural positions, for use by those who are disabled, and it is an object of the present invention to meet this requirement.

It is therefore an object of the present invention to provide a personal mobility vehicle that allows the user to have a maximal choice of body and postural positions whilst operating the vehicle, according to their preference, needs, environment, medical condition etc.

It is a further object of the present invention to provide a mobility vehicle that allows easy and safe access for the user to mount and dismount the vehicle and to allow the user to easily and readily choose their preferred body and postural position whist mounting or operating the vehicle.

It is a further object of the present invention to provide a personal mobility vehicle which allows the user to easily and readily choose between different body and postural positions whilst using the vehicle.

It is a further object of the present invention to provide a personal mobility vehicle which allows the user to easily and readily choose between different body and postural positions and to safely alter or change their body and postural position whilst using the vehicle.

It is a further object of the present invention to provide a personal mobility vehicle which allows the user to easily and readily choose between different body and postural positions such as sitting; reclining; lying: high-sitting; perching; supported forward, rearward or sideward leaning or resting; standing, or any position in between said positions whilst operating the vehicle.

It is a further object of the present invention to provide a personal mobility vehicle which allows the user to easily operate the vehicle in any chosen body or postural position.

It is a further object of the present invention to provide a personal mobility vehicle which increases activity, which can lead to a decreased susceptibility to weight gain, obesity, osteoporosis, reduced muscle strength, diabetes, reduced blood circulation and problems with digestion.

It is a further object of the present invention to provide a personal mobility vehicle that reduces feelings of stigma and demeaning as the user can choose a body position that allows them to be at a similar body position, face-to-face and at eye-level to those around them.

It is a further object of the present invention to provide a personal mobility vehicle that gives a greater sense of overall wellbeing.

It is a further object of the present invention to provide a personal mobility vehicle wherein the user is not limited in their ability to see, observe, and interact with, their surroundings.

It is a further object of the present invention to provide a personal mobility vehicle wherein the user is not limited in their ability to converse and interact at the same level as others around them.

It is a further object of the present invention to provide a personal mobility vehicle which is exceptionally manoeuvrable.

It is a further object of the present invention to provide a personal mobility vehicle which can be easily folded for transportation and stowage.

It is a further object of the present invention to provide a personal mobility vehicle which can be easily dismantled for transportation or in order to be stored.

It is a further object of the present invention to provide a personal mobility vehicle which has adjustability of the vehicle's component parts, in particular the front, rear and any additional columns and front, rear and side body stabilising support rests, particularly for height, forwards, backwards, inclination, rake, tilt and rotation.

It is a further object of the present invention to provide a personal mobility vehicle which is stable during use, with particular attention to when the vehicle is turning, even at full speed.

It is a further object of the present invention to provide a personal mobility vehicle which is safe during use.

It is a further object of the present invention to provide a personal mobility vehicle which is suitable for both indoor and outdoor terrain and environments.

It is a further object of the present invention to provide a personal mobility vehicle which is able to be easily controlled by an attendant, carer or companion.

It is a further object of the present invention to provide a personal mobility vehicle which is cost-effective with respect to production costs and relatively inexpensive and affordable.

### SUMMARY OF THE INVENTION

According to the present invention there is provided a personal mobility vehicle comprising a chassis/frame, including a platform upon which the user is supported by, or stands upon, whilst mounting, or operating the vehicle, ground-engaging wheels upon which the chassis is supported, motor drive means, motor power means, motor control means, power control means, braking control means, steering control means, at least one column extending upwards from the platform and at least one body stabilising support rest above the platform, which may be mounted on the at least one column.

The chassis is generally and preferably low profile so as to allow the user to easily and safely mount and dismount the mobility vehicle. This also contributes to a low centre of gravity for the vehicle to facilitate stability and safety. This also facilitates easy and safe access for the user to mount and dismount the vehicle.

The platform upon which the user is supported by, or stands upon, is also generally and preferably low profile, and lower in height relative to the height of the mid-wheel or mid-castor axle height. This also contributes to a low centre of gravity for the vehicle, to facilitate stability and safety. This also facilitates easy and safe access for the user to mount and dismount the vehicle and to allow the user to easily and readily choose their preferred body and postural position whist mounting and operating the vehicle.

The platform upon which the user is supported by, or stands upon, is easily and safely accessed by the user during, and after, mounting the vehicle, and unhindered by any other part of the vehicle, whereupon the user can freely choose their body position and posture before, during and after operating the vehicle.

The platform upon which the user is supported by, or stands upon, is preferably partly, or wholly, flat in profile.

The platform upon which the user is supported by, or stands upon, may be a standing platform.

The platform upon which the user is supported by, or stands upon is preferably partly, or wholly, a platform upon which the user may stand, unhindered by any other part of the vehicle.

The platform upon which the user is supported by, or stands upon, may be upwardly angled at the front of said platform to allow the user to rest their feet, especially when the user is perching, high-sitting or sitting.

The platform upon which the user is supported by, or stands upon is preferably partly, or completely covered in a non-slip material.

Protective material may be provided on the chassis/frame and platform, in particular to the sides of the chassis/frame and platform, which may be susceptible to contact with the environment that the vehicle is being used within, and also to the upper side of the platform which may be covered in a non-slip material to prevent the user slipping.

The ground-engaging wheels may include one or more driven wheels.

Furthermore, the ground-engaging wheels may include one or more undriven wheels.

The undriven wheels may include one or more castor wheels, omni-directional wheels, idler wheels or alternatively any other form of ground-engaging components.

The ground-engaging wheels may comprise any combination of driven wheels, undriven wheels, castor-type wheels, omni-directional wheels, idler wheels or alternatively any other form of ground-engaging components.

The ground-engaging wheels may comprise one or more driven wheels at the rear of the platform and one or more undriven wheels at the front of the platform. Alternatively, the ground-engaging wheels may comprise one or more driven wheels at the front of the platform and one or more undriven wheels at the rear of the platform. Alternatively, the ground-engaging wheels may comprise one or more driven wheels at or near the centre or middle of the platform and one or more undriven wheels at the front and/or rear of the platform.

Alternatively, the ground-engaging wheels may comprise driven wheels only, for example self-balancing wheels. Alternatively, the ground-engaging wheels may comprise driven wheels only, for example a four-wheel drive system may be provided, which may also facilitate steering of the vehicle. Alternatively, any other combination of driven and undriven wheels may be provided.

In some aspects and embodiments steering, speed, movement and directional control can be effected by a self-balancing, gyroscopic arrangement including, for example, self-balancing and/or gyroscopic wheels, whether on their own or in combination with castor-type wheels, omni-directional type wheels, idler wheels or any other type of ground-engaging wheels or vehicle supports.

The ground-engaging wheels and tyres may be of any dimensions and constructed so as to be suitable for whatever terrain the vehicle is used in and on, and for either or both indoor and outdoor terrain and environments.

The driven wheels may be controlled independently of each other, for example to facilitate steering of the vehicle.

The wheels may be recessed under the chassis/frame and/or platform to maintain a low platform profile and a low centre of gravity whilst maintaining freedom of movement of the wheels.

A number of idler wheels may also be provided at the front, rear and/or side of the underside of the chassis/frame or platform to prevent tipping of the vehicle when, for example, it is being driven over uneven ground or an incline or over ramps.

A number of idler wheels may additionally, or alternatively, be provided on parts of the vertical sides of the platform to prevent any unwanted sideways movement; to ensure maximum stability of the vehicle, for example whilst driving through narrow spaces such as doorways, or driving against walls etc.

Driving of the driven wheels is preferably effected by means of motors, which may be conventional motor-gearbox types, hub motors or any suitable alternative motors.

The motors are preferably powered by means of batteries, which may be any sort and size and can comprise the conventional lead-acid type, lithium, lithium-ion or any suitable alternatives.

The power means may be any that is suitable.

The power means may be electrical and constructed as a battery pack, which can be of any sort and size, and mounted at any convenient position on the vehicle. The personal mobility vehicle may have different interchangeable battery packs, each one of which can be used according to the intended usage. The batteries may be rechargeable and detachable for charging or transportation. The voltage and capacity can be of any that is suitable.

The battery pack can be so mounted that it is quickly and easily replaced with another, and this can be of either the same amperage or of a different amperage depending on requirements.

Both the motor control means and power control means may each be effected by any that is suitable. This may take the form of throttle and speed control potentiometers actuated by the user moving levers to control said power and motors, a joystick type of controller that effects the power and motor control, a twist-grip type of power controller, or any suitable alternatives.

Steering control means may comprise a conventional steering tiller, steering wheel, a joystick type of controller, a twist-grip type of power controller, potentiometer, twin-potentiometer, or any suitable alternatives.

Furthermore, the steering control means may be effected by a combination of any of the aforementioned steering control means.

Accordingly, the steering control means may be effected by a joystick controller plus a conventional steering tiller.

Furthermore, the steering control means may comprise a potentiometer or twin-potentiometer arrangement located in the tiller, or other location, to effect the steering control.

Furthermore, the steering control means may be effected by dual potentiometers arranged in combination with levers actuated by the user moving said levers in the required direction.

Furthermore, the steering control means may be located anywhere on the vehicle.

Furthermore, said steering control means, power control means and motor control means may work in any combination.

At least one hand or palm support rest may be mounted adjacent to one or more of the motor control means, power control means, braking control means and steering control means to facilitate comfortable resting of the hand or palm thereupon whilst operating said control means during the operation of the vehicle whilst the user is in any desired body position.

Preferably, a joystick type of controller is provided to effect the motor control means, power control means, braking control means and steering control means. By utilizing a joystick type of controller, the need for a traditional steering tiller is eliminated as the motors can be controlled independently by the joystick to effect the steering of the vehicle.

Furthermore, due to the ability of the joystick to effect independent-control of the motors, the nature of the design, construction and controller programming of the vehicle, the personal mobility vehicle according to the present invention slows down automatically when turning, further adding to its stability and increasing the confidence of the user. This also greatly increases the stability of the mobility vehicle as the centre of gravity remains within the platform dimensions and, in turn, virtually eliminates the risk of the vehicle tipping whilst turning.

Furthermore, manoeuvrability is greatly increased due to the enhanced turning ability of the mobility vehicle.

The braking control means act directly on at least one of the motors, at least one of the wheels, or any that is suitable. It may comprise an electromagnetic type of brake acting on at least one of the driven wheels or motors. This may act directly upon, or be incorporated into, at least one of the driven or undriven wheels or be incorporated into at least one of the motors (particularly if hub motors are utilised).

The braking means may alternatively comprise a mechanical type of brake acting upon any of the wheels or motors. Alternatively, the braking means may be actuated, effected and utilised by any suitable means.

The at least one column may include a column extending from the front part of the vehicle, may include a column extending from the rear part of the vehicle and may include a column, or columns, extending from other parts of the vehicle.

The at least one column extending from the front, rear and any additional columns may be fully adjustable, particularly for height, forward and backwards, inclination, rake, tilt and rotation.

Columns may be manually adjustable. Alternatively or additionally, adjustable columns could be adjusted by powered means, for example by powering a motor or motors electrically using power from the vehicle's own power source or by an additional power source (e.g. additional battery).

Furthermore, said at least one front, rear and side columns may be releasably-attached and removable from the vehicle.

The column extending from the front part of the vehicle may include at least one body stabilising support rest located adjacent to and/or mounted on said column and may be mounted on any part of said column including on any other component that is mounted on said column.

The column extending from the rear part of the vehicle may include at least one body stabilising support rest located adjacent to and/or mounted on said column and may be mounted on any part of said column including on any other component that is mounted on said column.

The column, or columns, extending from another part of the vehicle may include at least one body stabilising support rest located adjacent to and/or mounted on said column or columns and may be mounted on any part of said column or columns including on any other component that is mounted on said column or columns.

The at least one body stabilising support rest may include a body stabilising support rest for stabilising and supporting some or all of the front of the user's body, whether said user is in a standing, supported forward, leaning forward, sideward leaning, rearward, leaning, rearward resting, perching; high-sitting; sitting; reclining; lying, or any position in between said positions whilst operating the vehicle.

The at least one body stabilising support rest may include a body stabilising support rest for stabilising and supporting some or all of the rear of the user's body, whether said user is in a standing, supported forward, leaning forward, sideward leaning, rearward, leaning, rearward resting, perching; high-sitting; sitting; reclining; lying, or any position in between said positions whilst operating the vehicle.

The at least one body stabilising support rest may include a body stabilising support rest for stabilising and supporting some or all of at least one side of the user's body, whether said user is in a standing, supported forward, leaning forward, sideward leaning, rearward, leaning, rearward resting, perching; high-sitting; sitting; reclining; lying, or any position in between said positions whilst operating the vehicle.

The at least one body stabilising support rest for stabilising and supporting the front of the user's body may support the front of the user's body, thereby increasing support and stability for the user whilst operating the vehicle.

The at least one body stabilising support rest for stabilising and supporting the rear of the user's body may support some or all of the rear of the user's body, thereby increasing support and stability for the user whilst operating the vehicle.

The at least one body stabilising support rest for stabilising and supporting the at least one side of the user's body may support some or all of at least one side of the user's body, thereby increasing support and stability for the user whilst operating the vehicle.

The at least one body stabilising support rest for stabilising and supporting the front of the user's body may support the front of the user's body wherein the user may lean in a forward manner against said support rest, thereby increasing support and stability for the user whilst operating the vehicle.

The at least one body stabilising support rest for stabilising and supporting the rear of the user's body may support the rear of the user's body wherein the user may lean in a backward manner against said support rest, thereby increasing support and stability for the user whilst operating the vehicle.

The at least one body stabilising support rest for stabilising and supporting at least one side of the user's body may support at least one side of the user's body wherein the user may lean in a sideways manner against said support rest, thereby increasing support and stability for the user whilst operating the vehicle.

The at least one body stabilising support rest for stabilising and supporting the front, rear and at least one side of the user's body may be fully adjustable, particularly for height, forwards, backwards, inclination, rake, tilt and rotation

The at least one body stabilising support rest for stabilising and supporting the front, rear and at least one side of the user's body may be shaped, contoured, angled and adjustable so as to be complimentary the user's body shape and may comprise foam, memory foam or any other suitable material, covered with a non-slip material such as canvas, a neoprene-type-based, faux leather or any other suitable material.

The column extending from the front part of the vehicle may include an upper part which may include at least one handle and/or a handlebar, storage compartment(s), and other components located and/or mounted on said column.

The upper part of the column extending from the front part of the vehicle may include at least one of the at least one body stabilising support rests for stabilising and supporting the front of the user's body and may include support for the front of the user's body, which may comprise a body stabilising support rest mounted on said column to facilitate the user to be able to position themselves in any suitable manner including standing, supported forward, leaning forward, sideward leaning, rearward, leaning, rearward resting, perching; high-sitting; sitting; reclining; lying, or any other suitable position whilst on or operating the vehicle.

Said body stabilising support rest mounted on the upper part of the front column may include means for the user to grasp said upper part of the column, which may comprise at least one handle and/or a handlebar which the user can readily grasp with their hands. The handles and/or handlebar may additionally comprise grips to facilitate the comfortable grasping of said handles and/or handlebar by the user's hands.

Alternatively, any other suitable means to facilitate the user to be able to grasp the upper part of the front column may be included. Additionally, said support rest is preferably fully adjustable, particularly for height, forwards, backwards, inclination, rake, tilt and rotation.

Said body stabilising support rest mounted on the upper part of the front column may be releasably-attached and removable.

The steering control means, power control means and/or motor control means may be located within the proximity of the at least one handle and/or handlebars.

If the steering control means, power control means and/or motor control means comprises a joystick type of controller, this may be conveniently located within the proximity of said at least one handle and or handlebars so that it is able to be easily operated by the user.

At least one hand or palm support rest may be mounted adjacent to said joystick to facilitate comfortable resting of the hand or palm thereupon whilst operating said joystick during the operation of the vehicle whilst the user is in any desired body position.

Additionally, if the steering control means, power control means and/or motor control means comprises at least one twist grip type of controller, this or these may be conveniently located within the proximity of said at least one handle and or handlebars so that it or they are able to be easily operated by the user.

The at least one body stabilising support rest for stabilising and supporting the front of the user's body may support the front of the user's body wherein the user may lean in a forward manner against said support rest, thereby increasing support and stability for the user whilst operating the vehicle and said support rest is preferably so positioned that, when the user leans forward against said at least one support rest, the user is able to grasp and, if necessary, pull back on, the at least one handle or handlebars, thereby effectively neutralizing any shift in the centre of gravity of the user and giving the user an improved sense of stability while driving the vehicle. This improved sense of stability enhances the confidence of the user and this improvement in confidence can be of significant benefit.

The column extending from the rear part of the vehicle may include an upper part which may include at least one body stabilising support rest, storage compartment(s), and other components located adjacent to and/or mounted on said column.

The upper part of the column extending from the rear part of the vehicle may include at least one of the at least one body stabilising support rests for stabilising and supporting the rear of the user's body and may include support for the rear of the user's body, which may comprise a body stabilising support rest mounted adjacent to and/or on said column to facilitate the user to be able to position themselves in any suitable manner including standing, supported forward, leaning forward, sideward leaning, rearward, leaning, rearward resting, perching; high-sitting; sitting; reclining; lying, or any other suitable position whilst on or operating the vehicle.

Said body stabilising support rest mounted on the upper part of the rear column may be in any form that is suitable to facilitate the user to be able to position themselves in any suitable manner including standing, supported forward, leaning forward, sideward leaning, rearward, leaning, rearward resting, perching; high-sitting; sitting; reclining; lying, or any other suitable position whilst on or operating the vehicle.

Said support rest is preferably fully adjustable, particularly for height, forwards, backwards, inclination, rake, tilt and rotation.

Said body stabilising support rest mounted on the upper part of the rear column may be releasably-attached and removable.

Said body stabilising support rest mounted on the upper part of the rear column may be constructed partially, or totally, in the form of a seat.

Said seat is preferably constructed in such a way that allows, and assists, the user to be supported whilst adopting any suitable and desired position.

Said seat may be angled, shaped and padded so as to be complimentary to the user's body shape.

Said seat may include a backrest.

Said seat may include at least one armrest.

Said seat is preferably fully adjustable, particularly for height, forwards, backwards, inclination, rake, tilt and rotation.

Said seat preferably tilts in a generally upwards, downwards, forwards and backwards manner.

Said seat is preferably rotatable to facilitate ease of access for the user whilst mounting and dismounting the vehicle.

Said seat may be releasably-attached and removable.

A spring-loaded mechanism may be incorporated adjacent or within said rear column and seat which is capable of applying resistance against said seat and which actuates said seat in such a manner that facilitates said seat to rise and/or tilt in accordance with the amount of load placed upon it.

Said spring-loaded mechanism acts in such a way that the seat may be positioned at any point between the horizontal and the vertical positions.

The resistance of said spring-loaded mechanism may be adjustable according to the user's preference, weight, height etc.

The resistance of said spring-loaded mechanism may be able to be omitted if desired.

Accordingly, when the user is positioned in any suitable manner on or against said seat, said spring-loaded mechanism enables the user to apply counter-resistance and/or load against said seat and allows the user to rise and lower against the resistance of said spring-loaded mechanism so that they may safely change their position to and from standing, supported forward, leaning forward, sideward leaning, rearward, leaning, rearward resting, perching; high-sitting; sitting; reclining; lying, or any position in between said positions whilst on or operating the vehicle, whenever they choose, with the assistance of the spring-loaded mechanism acting upon the seat.

Accordingly, the seat may facilitate the user to adopt any position they choose whilst being supported by said seat and to be able to safely change their position to any alternative position they choose.

Said seat position may be able to be fixed, temporarily, semi-permanently or permanently at any point between the horizontal and vertical positions.

Said spring-loaded mechanism may be actuated manually by the user's body applying varying amounts of counter-resistance against the seat.

Alternatively, said actuation of the spring-loaded mechanism may be effected by electric means, which may be facilitated by at least one motor, powered by the vehicle's own power means. Alternatively, at least one additional power source may power the at least one motor to effect the working of the spring-loaded mechanism.

Any other suitable alternative means to facilitate the user to be able to position themselves in any desired or suitable manner on, against or adjacent to the rear column may be included.

The at least one body stabilising support rest that may be included on the column extending from the front of the vehicle for stabilising and supporting the front of the user's body may be located anywhere on the front column. Said support rest may be located directly on the rear face of the front column, the storage compartment(s), the handle(s), handlebars, or any other suitable location.

The at least one body stabilising support rest that may be included or mounted on the column extending from the rear of the vehicle for stabilising and supporting the rear of the user's body may be located anywhere on the rear column. Said support rest may be located directly on the front face of the rear column, the top of the column, or any other suitable location.

The at least one body stabilising support rest that may be included or mounted on any column extending from any part of the vehicle for stabilising and supporting the side or sides of the user's body may be located anywhere suitable on the vehicle.

Any of the at least one front, rear and side body stabilising support rests may be utilised by the user individually, or in combination with each and any other.

Any of said columns extending from any part of the vehicle may include at least one body stabilising support rest located and/or mounted on said column and constructed in the form of a seat as previously herein described.

The at least one column is preferably pivotally mounted on the platform for movement between an operational position in which it extends upwardly from the platform and a storage or transport position in which it is folded towards, or against, the platform.

A variety of methods of folding and unfolding the at least one column may be provided. For example, the at least one column may be folded downwardly and centrally to meet the platform such that the vehicle is essentially flat in profile. The at least one column and/or the platform may fold in the middle or may fold with a scissors action. Alternatively, any suitable folding method means may be provided.

One or more electric motors may be provided for effecting the folding and unfolding operations, with operation of the motor(s) preferably controlled by means of a push-button control means. The control means may be attached to the vehicle, releasably-attached to the vehicle, or the motor(s) may be actuated by means of remote control.

Means for the main sections of the personal mobility vehicle according to the present invention to be quickly and easily detachable from each other is preferably provided to facilitate easy transportation and storage of the vehicle.

At least one means to facilitate storage of items may be provided on the vehicle.

Further features may comprise security devices such as a key or keys, power on/off button, a device to effect immobilisation of the vehicle; a USB power supply for charging mobile devices, and any other additional features.

An important advantage of the personal mobility vehicle of the present invention is that it allows the user to maintain a standing position, if desired so they can be at the same height as most able-bodied people and those around them. This helps to reduce the feeling of inferiority that many users experience and to remove the stigma attached to other mobility vehicles which, in turn, helps with the confidence of the users. It should also be noted that this can be a contributing factor to encourage the use of the personal mobility vehicle according to the present invention and can only be good for those who have previously refused to use a mobility vehicle in the past due to similar negative opinions.

Also, many disabled and elderly people have great difficulty sitting for long periods of time and then rising from a sitting position or vice versa. With the personal mobility vehicle of the present invention, people will be encouraged to remain more active as they can choose and change their body positions whenever they want and it is also easier to mount and dismount the mobility vehicle.

Another feature of the vehicle of the present invention is that it is very easy for an attendant to control. The steering, speed and braking control means are at a convenient height and can be controlled with one hand.

This contrasts with many other mobility vehicles which can be very difficult, if not impossible, for an attendant to control.

Another feature of the vehicle of the present invention is that it is environmentally friendly due to its electric battery power means, zero carbon emissions and all of the components can be recycled.

The frame and chassis can be composed of lightweight materials such as alloy, aluminum, magnesium or carbon fiber, or alternatively injection moulded material. Other components can be injection moulded or sourced ready-assembled and made according to the nature of the component.

The battery or battery pack can be of any number, composition and size, and may be a lithium, lithium-ion or lithium-phosphate battery pack and mounted at any convenient position on the vehicle. An additional battery pack may be carried on the vehicle, and/or attached to the onboard battery or battery pack, for example to give extra range or power.

Additional features such as suspension, lights, indicators, mirrors, additional storage, shopping bag, storage bag or case for the vehicle to be stored in, etc. can be provided.

Lifting and carry handles may be included on the mobility vehicle.

The personal mobility vehicle according to the present invention is more compact than other personal mobility vehicles. This compact size allows it to include, or to be conveniently stored in, a suitable case or storage bag, which may itself incorporate a carry handle and wheels for ease of transportation.

Safety of personal mobility vehicles is a very important issue. As users of the personal mobility vehicle according to the present invention are in a generally standing position and, therefore, higher and more visible than in or on other personal mobility vehicles, they will be able to see better and thus be more aware of their surroundings. They will also be seen by others more easily.

Example Benefits and Features of the Mobility Vehicle According to the Present Invention that May Be Used to Promote its Use:—

The mobility vehicle according to the present invention promotes a more interactive, and active, healthier lifestyle with a greater sense of overall wellbeing.

Ability to choose body, postural and operational positions.
Extremely stable
Extremely maneuverable
Easily folded
Folding columns
Can fold as one piece
Folds down into its own base dimensions
Single handed folding possible.
Sections easily separated
Levers with hydraulic damper mechanisms can be used for the folding operations
Additionally, or alternatively, traditional hinges, pins, C-clips, toothed joint brackets, etc could be used
Non-folding version an option
Single handed steering
Left or righthanded steering
Motors can operate each rear wheel individually
Omnidirectional steering
Turns within, or practically within, its own radius
Lightweight
When standing, user at similar height, and at eye level to those around them
Reduced stigma compared to other mobility vehicles
All section are fully adjustable
Cost-effective production and affordable purchase price
Generally smaller, lighter and easier to fold, lift, manoeuvre, transport and store
Compact size
Centre of gravity remains within the base during use
Easy to operate
Small and light batteries and battery pack
Short charging time
Could utilize power inverter in a motor vehicle 12v socket
Column very stable
Hands at natural, neutral and relaxed position
Arthritic-friendly handle grips
Joystick positioned for ideal comfort in any body position: minimal hand/finger movement required
Steering using joystick: easy to operate single-handed, arthritic-friendly
Possibility of multidirectional handle-type joystick for steering
Platform small and lightweight but stable and strong
Standing area for feet with non-slip material or textured moulding
No tiller steering necessary so no loss of stability
Front wheels don't cause the lateral friction which would otherwise shift centre of gravity and reduce stability
Turning sharply—no shift in centre of gravity to outside area of platform as the mobility vehicle slows automatically due to programming and the steering advantages facilitated by motors and wheels during steering
Tyres can be provided that have good frictional contact with all terrains
Wheels positioned for maximum ease of turning, support and stability
Ability to turn freely and without ‘lag’ felt in other personal mobility vehicles when changing direction Motor axles positioned behind feet to further increase stability
As well as the rear support rest, the front support rest can be used as a lean-to support rest or seat when mobility vehicle is not actually being operated
Storage positioned in between handles adjacent thigh support rest to maintain center of gravity and stability
If no tiller steering, there is no shift of centre of gravity or loss of stability
Motors can operate each driven wheel individually giving multidirectional steering
Equivalent to, and as stable as, standing with support from walking aids plus added support from the thigh support rest.

Different aspects and embodiments of the invention may be used separately or together.

Further particular and preferred aspects of the present invention are set out in the accompanying independent and dependent claims. Features of the dependent claims may be combined with the features of the independent claims as appropriate, and in combination other than those explicitly set out in the claims.

Each aspect can be carried out independently of the other aspects or in combination with one or more of the other aspects.

The present invention will now be more particularly described, by way of example, with reference to the accompanying drawings.

The example embodiments are described in sufficient detail to enable those of ordinary skill in the art to embody and implement the systems and processes herein described. It is important to understand that embodiments can be provided in many alternative forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In the following description, all orientational terms, such as upper, lower, radially and axially, are used in relation to the drawings and should not be interpreted as limiting on the invention.

### BRIEF DESCRIPTION OF THE DRAWINGS (BY WAY OF EXAMPLE ONLY)

FIG. 1 is a perspective view of an example of a personal mobility vehicle in accordance with the present invention, in an operational condition, looking towards the front right-hand side.

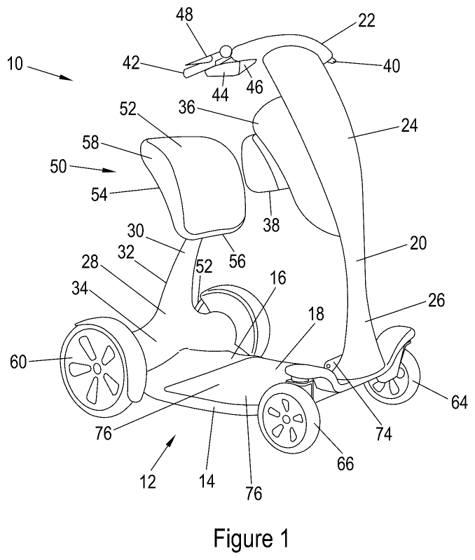

FIG. 2 is a perspective view of an example of a personal mobility vehicle in accordance with the present invention, in an operational condition, looking towards the rear left-hand side.

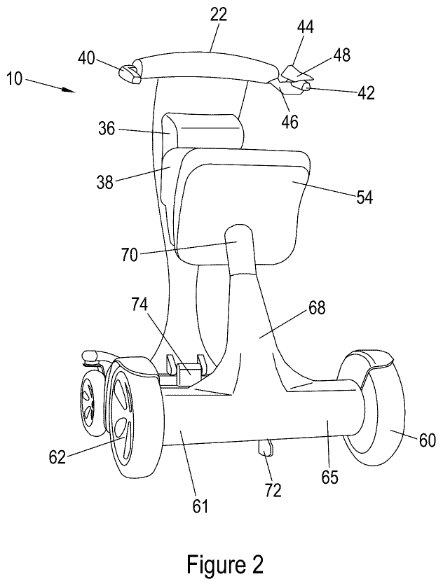

FIG. 3 is a perspective view of an example of a personal mobility vehicle in accordance with the present invention, in an operational condition, looking towards the rear right-hand side.

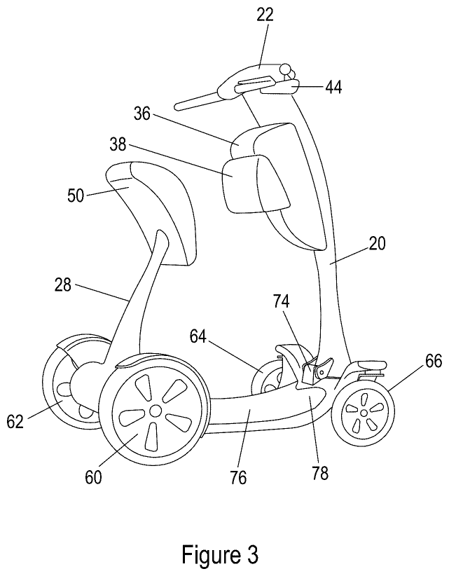

FIG. 4 is a front view of an example of a personal mobility vehicle in accordance with the present invention, in an operational condition, looking towards the front.

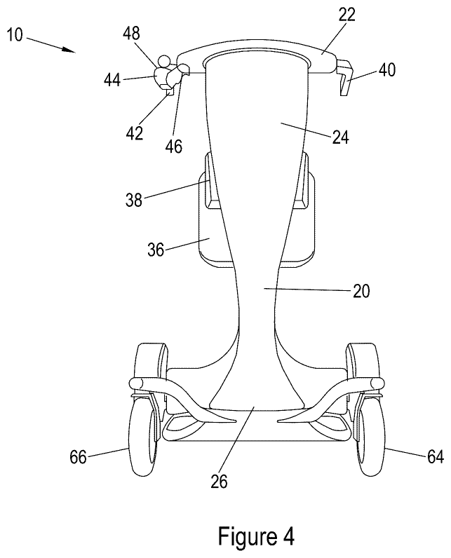

FIGS. 5A to 5C are perspective views of a personal mobility vehicle formed according to a further embodiment.

### DESCRIPTION OF A PREFERRED EMBODIMENT (BY WAY OF EXAMPLE ONLY)

The personal mobility vehicle 10 as shown in the drawings comprises:

A frame/chassis 12 including a platform 14, comprising a rear section 16, and a front section 18 upon which the user of the vehicle 10 can be supported by, or stand upon, whilst mounting, or operating the vehicle 10.

A column 20 is mounted on the front of platform 14 adjacent the centre of the front end thereof.

The front column comprises an upper section 22, middle section 24 and a lower section 26.

A column 28 is mounted on the rear of platform 14 adjacent the centre of the rear end thereof.

The rear column 28 comprises an upper section 30, a middle section 32 and a lower section 34.

A storage compartment 36 is mounted on the rear face of the middle section of the front column 20 and a body stabilising support rest 38 is mounted on the rear face of said storage compartment 36.

A handle 40 is mounted on the upper left side of the front column and a handle 42 is mounted adjacent to the upper right side of the front column.

A joystick controller 44 is mounted adjacent to the upper right side of the front column by means of bracket 46 mounted adjacent the upper right side of the front column 20.

A hand/palm rest 48 is mounted above said handle adjacent to the upper right side of the front column 20 to facilitate comfortable resting of the hand or palm thereupon whilst operating said joystick 44 during the operation of the vehicle 10 whilst the user is in any desired body position.

A body stabilising support rest 50 is mounted on the upper part of rear column 30 and comprises substantially a main upper section in the form of a seat 52, with a lower frame section 54, a front section 56 and side sections 58.

A spring-loaded mechanism 70 is located between said lower section 54 of said seat 52 and the upper part 30 of the rear column 28.

An electric motor 61 is located within the lower left hand side of the lower section 34 of the rear column 28 and an electric motor 65 is located within the lower right hand side of the lower section 34 of the rear column 28

An independently-driven ground-engaging drive wheel 62 is located adjacent the rear left of the platform 14 and is driven by motor 61 and an independently-driven ground-engaging right drive wheel 60 is located adjacent the rear right of the platform 14 and is driven by motor 65.

A ground-engaging omni-directional wheel 64 is located adjacent the front left of the platform 14 and a ground-engaging omni-directional wheel 66 is located adjacent the front right of the platform 14.

Power means in the form of a removable lithium-ion battery pack 68, is located in the lower section 34 of the rear column 28.

As can be seen in the drawings, both the lower part of the frame/chassis 12, and the platform 14 upon which the user is supported by, or stands upon, is flat and low in profile, easily and safely accessed by the user during, and after, mounting the vehicle 10, and unhindered by any other part of the vehicle 10, whereupon the user can freely choose their body position and posture before, during and after operating the vehicle 20.

Moreover, it will be seen that the platform 14 is at a lower level than the axis level of the ground-engaging wheels 60,62,64,66 to maintain a low centre of gravity and add to the stability of the vehicle 10 and safety of the user.

The platform 14 includes an upwardly angled 78 front section 18 which allows the user to rest their feet, especially when the user is perching, high-sitting or sitting.

The platform 14, including the upwardly angled 78 front section 18 is completely covered in a non-slip material 76.

Protective material may be provided on the chassis/frame 12 and platform 14, in particular to the sides of the chassis/frame 12 which may be susceptible to contact with the environment that the vehicle is being used within, and also to the upper side of the platform 14 which is covered in a non-slip material 76 to prevent the user slipping.

Both the front column 20 and rear column 28 are fully and conveniently adjustable for height, forwards, backwards and inclination.

Moreover, the front column 20 can be released from its fixed position by way of release mechanism 74 and folded down towards the platform 14 to a substantially horizontal position and the rear column 28 can be released from its fixed position by way of release mechanisms 72 and folded down towards the platform 14 to a substantially horizontal position. The mobility vehicle 10 can then be easily transported and/or conveniently stored in eg a car boot or in the home.

Each of the front 18 and rear sections 16 of the platform 14, and the front 20 and rear 28 columns can be separated from each other, using release mechanisms 74,72 for ease of transportation and/or in order to be conveniently stored in e.g., a car boot or in the home.

As can be seen in the drawings, two driven wheels 60,62 are located at the rear 16 of the platform 14 and two omni-directional wheels 64, 66 are located at the front 18 of the platform 14.

In alternative embodiments, the ground-engaging wheels may comprise any combination of driven wheels, undriven wheels, castor-type wheels, omni-directional wheels, idler wheels or alternatively any other form of ground-engaging components.

It will be seen from the drawings that the ground-engaging wheels 60,62,64,66 shown in the drawings are suitable for both indoor and outdoor terrain and environments, being of relatively large dimensions.

The joystick controller 44 mounted on the right side of the upper section 22 of the front column 20 effects the motor control means, power control means, braking control means and steering control means. By utilizing a joystick type of controller 44, the need for a traditional steering tiller is eliminated as the motors 61,65 are controlled independently by the joystick 44 to effect the steering of the vehicle.

It will be appreciated that in alternative embodiments the joystick controller 44 can be mounted on the left side of the upper section 22 of the front column 20, the centre of the upper section 22, or in any alternative position.

Furthermore, due to the ability of the joystick 44 to effect independent-control of the motors 61,65, the nature of the design, construction and controller programming of the vehicle 10, the personal mobility vehicle 10 according to the present invention slows down automatically when turning, further adding to its stability and increasing the confidence of the user. This also greatly increases the stability of the mobility vehicle 10 as the centre of gravity remains within the platform 14 dimensions and, in turn, virtually eliminates the risk of the vehicle tipping whilst turning.

Furthermore, maneouvrability is greatly increased due to the enhanced turning ability of the mobility vehicle 10.

The braking control means effected by the joystick controller 44 acts directly on each of the motors 61, 65 independently and comprises electromagnetic type of brakes acting on the motors 64, 66, which are incorporated into the body of the motors 61, 65.

Each of the handles 40, 42 is covered in comfortable and non-slip material 76 and shaped to compliment the user's hands.

The hand/palm rest 48 is mounted above the right handle 42 for comfortable operation of the joystick controller 44. Said hand/palm rest 48 facilitates comfortable resting of the hand or palm thereupon whilst operating said joystick controller 44 during the operation of the vehicle 10, whilst the user is in any desired body position.

The storage compartment 36 mounted on the middle section 24 of the front column 20 can be of any material and any dimensions.

The body stabilising support rest 38 mounted on the rear face of the storage compartment 36 is shaped, angled and composed of memory foam, covered with a neoprene-type-based non-slip material 76.

It will be seen that said body stabilising support rest 38 is shaped and angled so as to be complimentary to the front of the user's body when the user is standing on the platform 14 and resting against said support rest 38

The body stabilising support rest 50 mounted on the upper part 30 of rear column 28 comprises substantially an upper section in the form of a seat 52. Said seat 52 is shaped, angled and padded so as to be complimentary to a user's body and is composed of memory foam, covered with a neoprene-type-based non-slip material 76. The seat 52 is therefore comfortable and due to its complimentary shape and memory foam, contributes to the stability and safety of the user whilst operating the vehicle 10, especially whilst the user is sitting on said seat 52.

The front section 56 of the seat 52 allows the user to rest or lean their body against said seat 52 to aid stability whilst operating the vehicle 10 in any desired position, but especially whilst standing and operating the vehicle 10.

The spring-loaded mechanism 70 located between the lower section 54 of the body stabilising support rest 50 and the upper part 30 of the rear column 28 is capable of applying resistance against said support rest 54 and which actuates in such a manner that facilitates said support rest 54 to rise and/or tilt in accordance with the amount of load placed upon it.

Accordingly, when the user is positioned in any suitable manner on or against said seat 52, said spring-loaded mechanism 70 enables the user to apply counter-resistance and/or load against said seat 52 and allows the user to rise and lower against the resistance of said spring-loaded mechanism 70 so that they may safely change their position to and from standing, supported forward, leaning forward, sideward leaning, rearward, leaning, rearward resting, perching; high-sitting; sitting; reclining; lying, or any position in between said positions whilst on or operating the vehicle 10, whenever they choose, with the assistance of the spring-loaded mechanism X acting upon the support rest 50

Accordingly, the support rest 50 may facilitate the user to adopt any position they choose whilst being supported by said seat 52 and to be able to safely change their position to any alternative position they choose.

Said seat 52 position may be fixed temporarily, semi-permanently or permanently at any point between the horizontal and vertical positions.

Said spring-loaded mechanism 70 acts in such a way that the rear support rest 50 can be positioned at any point between the horizontal and the vertical positions.

Said rear support rest 50 tilts in a generally upwards, downwards, forwards and backwards manner.

The resistance of said spring-loaded mechanism 70 is adjustable according to a user's preference, weight, height etc.

The resistance of said spring-loaded mechanism 70 may be omitted if desired.

Said support rest 50 is fully adjustable, particularly for height, forwards, backwards, inclination, rake, tilt and rotation.

Said support rest 50 is rotatable and can be swiveled by the user from its fixed position upon actuation of a release mechanism and can be rotated to a point anywhere within 360 degrees of rotation and then fixed again wherever it is desired. This function contributes to the ease of access during the mounting and dismounting of the vehicle 10.

Said seat 52 is preferably rotatable to facilitate ease of access for the user whilst mounting and dismounting the vehicle.

Said seat 52 and the whole of said support rest 50 is releasably-attached and is removable.

Said spring-loaded mechanism 70 is actuated manually by the user's body applying varying amounts of counter-resistance and/or load against the seat 52.

In alternative embodiments, said actuation of the spring-loaded mechanism 70 may be effected by electric means, which may be facilitated by at least one motor, powered by the vehicle's 10 own power means. Alternatively, at least one additional power source may power the at least one motor to effect the working of the spring-loaded mechanism 70.

It will be appreciated that, whilst standing and operating the vehicle 10, the user may lean forward against the front body stabilising support rest 38 mounted on the front column 20, the body stabilising support rest 54 mounted on the rear column 28, or can be supported by both the body stabilising support rest 38 mounted on the front column 20 and the body stabilising support rest 54 mounted on the rear column 28 simultaneously, for extra support and stability.

It will be appreciated that the personal mobility vehicle 10 according to the present invention can be easily and readily controlled by an attendant, carer or companion if needed or necessary.

### An Example of how the Personal Mobility Vehicle can be Used

The user conveniently and easily enters the mobility vehicle 10 from the chosen side, taking hold of the nearest of the handles 40, 42 with one hand. They then mount the mobility vehicle 10 by stepping onto the platform 14, one foot at a time, taking hold of the other handle 40,42 with their other hand as they do so.

They then choose their intended initial body and postural position, such as standing, leaning, resting, perching, high-sitting, sitting, reclining, lying, or any position in between said positions, according to their preference, needs, environment, medical condition etc.

In this example, they will adopt the standing position, using the body stabilizing support 38 on the front column 20 for support.

Accordingly, still holding both handles 40, 42, the user gently but firmly leans the front of their body onto and against said support 38.

Once they feel comfortably supported, they switch the mobility vehicle 10 on.

They then rest their palm/hand on the palm/hand rest 48 and take hold of the joystick 44, they set the maximum speed and can now move the vehicle 10 in any desired direction and with any desired speed, up to the maximum setting. Whenever they wish to slow down or stop, they simply move the joystick 44 towards the centre position on the joystick controller 44. When they bring the joystick 44 to the centre completely, the braking means is activated and the vehicle 10 comes to a gradual stop.

Once the user has completed their journey, they switch off the joystick controller 44 and dismount the vehicle 10 from their chosen side, carrying out the reverse procedure to when they mounted the vehicle 10 as previously described.

The above and alternative body and postural positions the user can choose are summarized below, by way of non-limiting examples:

Standing method 1: As described above, the user enters the vehicle 10 from their chosen side, gently but firmly leans the front of their body onto and against the body stabilizing support rest 38 on the front column 20 for support.

Standing method 2: The user mounts the mobility vehicle 20 as described above and gently but firmly leans against the body stabilizing support 50 on the rear section 28 for support, holds the handles 40, 42 with their hands and operates the vehicle 10 as previously described, with the spring-loaded rear support rest 50 not lowered against load and is essentially still vertical.

Standing method 3: The user mounts the mobility vehicle 10 as described above and the user positions their body between the body stabilizing support 38 on the front column 20 and the body stabilizing support rest 50 on rear column 28 and so is supported by both said front 38 and rear 50 supports simultaneously, holds the handles 40,42 with their hands and operates the vehicle 10 as previously described, with the spring-loaded rear support rest 50 not lowered against load and is essentially still vertical.

High sitting method: The user mounts the mobility vehicle 10 as described above and the user positions the rear of their body so that it rests and is leant against the front 56 and upper 52 sections of the rear body stabilizing support rest 50, but still in an essentially upright position, with the spring-loaded support rest 50 only minimally lowered against load. The user may also rest against the front support rest 38 to some extent if desired.

Perching method: The user mounts the mobility vehicle 10 as described above and the user positions the rear of their body so that it rests and is substantially resting on the top section 52 of the rear body stabilizing support rest 54, but still in an essentially half-sitting, half-standing position, with the spring-loaded rear support rest 50 approximately halfway lowered against load. The user may also rest against the front support rest 38 to some extent if desired.

Sitting method: The user mounts the mobility vehicle 10 as described above and the user positions the rear of their body so that it rests substantially resting on the top section 52 of the rear body stabilizing support rest 54 with the spring-loaded rear support rest 50 fully lowered against load. The user may also rest against the front support rest 38 to some extent if desired.

Reclining/lying method: The user mounts the mobility vehicle 10 as described above and the user positions the rear of their body so that it rests substantially resting on the top section 52 of the rear body stabilizing support rest 50, with the spring-loaded rear support rest 50 fully lowered against load. The user can then recline backwards. The user may also rest against the front support rest 38 to some extent if desired.

Should the user wish to fold the mobility vehicle 10, they release the rear column 28 using the release mechanism 72 and lower it towards the platform 14, and then they release the front column 20 using the release mechanism 74 and lower it towards the platform 14.

Should the user wish to separate any of the sections 16,18 and columns 20,28, they can release any of the sections 16,18,20,28 using release mechanisms 74,72

It will be seen and appreciated that the personal mobility vehicle 10 according to the present invention herein disclosed has met all of its aims, objects and objectives hereinafter described.

In summary, the mobility vehicle 10 according to the present invention promotes a more interactive, and active, healthier lifestyle with a greater sense of overall wellbeing.

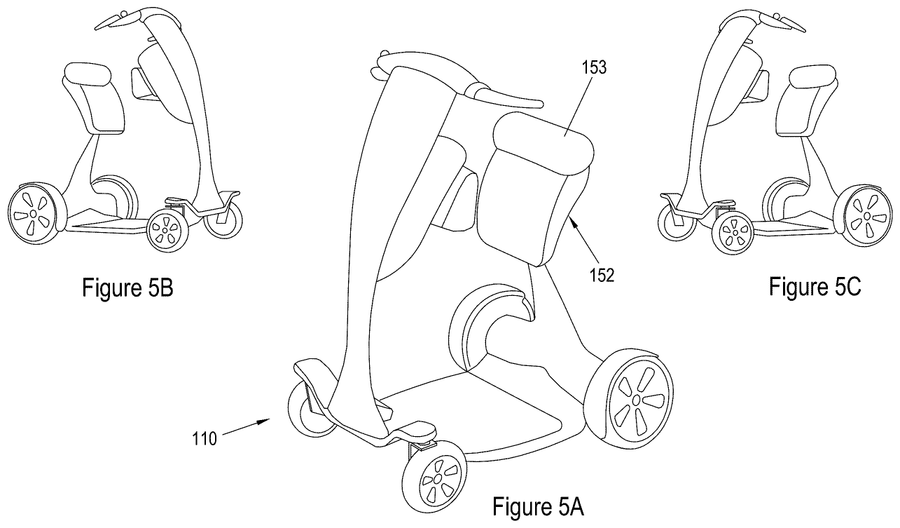

FIGS. 5A to 5C show mobility vehicle 110 formed according to a further embodiment.

In this embodiment a backrest 153 (for the seat) 152 is provided.

The invention herein disclosed is capable any number of variations, modifications and changes, all of which are in the scope of the inventive concept.

1. A personal mobility vehicle comprising a chassis, including a platform upon which a user is supported by, or stands upon, whilst mounting, or operating the vehicle, ground-engaging wheels upon which the chassis is supported, and in which the vehicle comprises at least one body stabilising support.

2. A personal mobility vehicle comprising a chassis/frame, including a platform upon which the user is supported by, or stands upon, whilst mounting, or operating the vehicle, ground-engaging wheels upon which the chassis is supported, motor drive means, motor power means, motor control means, power control means, braking control means, steering control means, at least one column extending upwards from the platform and at least one front body stabilising support rests above the platform, which is mounted on the at least one column.

3. A personal mobility vehicle comprising a chassis including a platform upon which a user is supported by, or stands upon, whilst mounting, or operating the vehicle, ground-engaging wheel or other rolling support means, a rear column, at least one rear body stabilising support is provided on or by the rear column, a front column, at least one front body stabilizing support is provided on or by the front column, the user's body is supported between the rear and front body stabilising supports.

4. The vehicle according to claim 1, in which at least one body stabilising support rest includes a body stabilising support rest for stabilising and supporting some or all of the front of the user's body, whether said user is in a standing, supported forward, leaning forward, sideward leaning, rearward, leaning, rearward resting, perching; high-sitting; sitting; reclining; lying, or any position in between said positions whilst operating the vehicle.

5. The vehicle according to claim 1, in which at least one body stabilising support rest includes a body stabilising support rest for stabilising and supporting some or all of the rear of the user's body, whether said user is in a standing, supported forward, leaning forward, sideward leaning, rearward, leaning, rearward resting, perching; high-sitting; sitting; reclining; lying, or any position in between said positions whilst operating the vehicle.

6. The vehicle according to claim 1, in which at least one body stabilising support rest includes a body stabilising support rest for stabilising and supporting some or all of at least one side of the user's body, whether said user is in a standing, supported forward, leaning forward, sideward leaning, rearward, leaning, rearward resting, perching; high-sitting; sitting; reclining; lying, or any position in between said positions whilst operating the vehicle.

7. The vehicle according to claim 1, in which the at least one body stabilising support rest for stabilising and supporting the front of the user's body supports the front of the user's body, thereby increasing support and stability for the user whilst operating the vehicle.

8. The vehicle according to claim 1, in which at least one body stabilising support rest for stabilising and supporting the rear of the user's body supports some or all of the rear of the user's body, thereby increasing support and stability for the user whilst operating the vehicle.

9. The vehicle according to claim 1, in which at least one body stabilising support rest for stabilising and supporting the at least one side of the user's body supports some or all of at least one side of the user's body, thereby increasing support and stability for the user whilst operating the vehicle.

10. The vehicle according to claim 1, in which at least one body stabilising support rest for stabilising and supporting the front of the user's body supports the front of the user's body wherein the user may lean in a forward manner against said support rest, thereby increasing support and stability for the user whilst operating the vehicle.

11. The vehicle according to claim 1, in which at least one body stabilising support rest for stabilising and supporting the rear of the user's body supports the rear of the user's body wherein the user may lean in a backward manner against said support rest, thereby increasing support and stability for the user whilst operating the vehicle.

12. The vehicle according to claim 1, in which at least one body stabilising support rest for stabilising and supporting at least one side of the user's body supports at least one side of the user's body wherein the user may lean in a sideways manner against said support rest, thereby increasing support and stability for the user whilst operating the vehicle.

13. The vehicle according to claim 1, in which at least one body stabilising support rest for stabilising and supporting the front, rear and at least one side of the user's body is preferably fully adjustable, particularly for height, forwards, backwards, inclination, rake, tilt and rotation

14. The vehicle according to claim 1, in which at least one body stabilising support rest for stabilising and supporting the front, rear and at least one side of the user's body is preferably shaped, contoured, angled and adjustable so as to be complimentary the user's body shape and comprises foam, memory foam or any other suitable material, covered with a non-slip material such as canvas, a neoprene-type-based, faux leather or any other suitable material.

15. (canceled)

16. The vehicle according to claim 1, in which a front body stabilising support rest is shaped and angled so as to be complimentary to the front of the user's body when the user is standing on the platform, and, in which a rear body stabilising support rest comprises an upper section in the form of a seat, said seat being shaped and angled as to be complimentary to a user's body when a user is standing on the platform and/or in which the chassis is low profile.

17-18. (canceled)

19. The vehicle according to claim 1, in which: ground-engaging wheels comprise one or more driven wheels at the rear of the platform and one or more undriven wheels at the front of the platform; ground-engaging wheels comprise one or more driven wheels at the front of the platform and one or more undriven wheels at the rear of the platform; ground-engaging wheels comprise one or more driven wheels at or near the centre or middle of the platform and one or more undriven wheels at the front and/or rear of the platform; ground-engaging wheels comprise driven wheels only, for example self-balancing wheels; ground-engaging wheels comprise driven wheels only, for example a four-wheel drive system may be provided, which may also facilitate steering of the vehicle; or any other combination of driven and undriven wheels.

20. (canceled)

21. The vehicle according to claim 1, in which at least one column extending from the front, rear and any additional columns are fully adjustable, particularly for height, forward and backwards, inclination, rake, tilt and rotation and/or in which a column extending from a front part of the vehicle includes an upper part which includes at least one handle and/or a handlebar, storage compartment(s), and other components located and/or mounted on said column and/or in which steering control means comprises a steering tiller, steering wheel, a joystick type of controller, a twist-grip type of power controller, potentiometer, twin-potentiometer, or any suitable alternatives.

22. (canceled)

23. The vehicle according to claim 1, in which an upper part of a column extending from the front part of the vehicle includes at least one of the at least one body stabilising support rests for stabilising and supporting the front of the user's body and includes support for the front of the user's body, which comprises a body stabilising support rest mounted on said column to facilitate the user to be able to position themselves in any suitable manner including standing, supported forward, leaning forward, sideward leaning, rearward, leaning, rearward resting, perching; high-sitting; sitting; reclining; lying, or any other suitable position whilst on or operating the vehicle.

24. The vehicle according to claim 1, in which a body stabilising support rest mounted on an upper part of a front column includes means for the user to grasp said upper part of the column, which mf-ay comprises at least one handle and/or a handlebar which the user can readily grasp with their hands.

25. The vehicle according to claim 1, in which a spring-loaded mechanism is incorporated adjacent or within a rear column and/or seat which is capable of applying resistance against said seat and which actuates said seat in such a manner that facilitates said seat to rise and/or tilt in accordance with an amount of load placed upon it, and in which when the user is positioned in any suitable manner on or against said seat, said spring-loaded mechanism enables the user to apply counter-resistance and/or load against said seat and allows the user to rise and lower against the resistance of said spring-loaded mechanism so that they may safely change their position to and from standing, supported forward, leaning forward, sideward leaning, rearward, leaning, rearward resting, perching; high-sitting; sitting; reclining; lying, or any position in between said positions whilst on or operating the vehicle, whenever they choose, with the assistance of the spring-loaded mechanism acting upon the seat.
